(19) United States
(12) Patent Application Publication
(10) Pub. No.: US 2026/0089184 A1
(43) Pub. Date: Mar. 26, 2026

(54) DEVICE FOR SECURE COMMUNICATION IN AN ETHERNET-BASED BUS SYSTEM AND METHOD FOR AUTHENTICATING ETHERNET FRAMES

(71) Applicant: Infineon Technologies AG, Neubiberg (DE)

(72) Inventors: Laurent HEIDT, Sauerlach (DE); Tobias ISLINGER, Höhenkirchen-Siegertsbrunn (DE); Abhijit AMBEKAR, Munich (DE); Christian BOIGER, Moosthenning (DE)

(21) Appl. No.: 19/338,905

(22) Filed: Sep. 24, 2025

(30) Foreign Application Priority Data
Sep. 26, 2024 (DE) 102024209355.6

(51) Int. Cl. H04L 9/40; H04L 12/40

(52) U.S. Cl. CPC H04L 63/1441; H04L 12/40006; H04L 63/1408

(57) ABSTRACT

A device provides secure communication in an Ethernet-based half-duplex multidrop bus system. The device has a physical interface for receiving and transmitting Ethernet frames on the physical layer, and a process unit for processing the Ethernet frames on the data link layer. The device is configured to transmit an Ethernet frame via the physical interface only at a transmission time that has been exclusively reserved and specified by a bus master. The device has a monitoring unit that is configured to carry out an authenticity check on a received Ethernet frame coming from another network participant by matching the received Ethernet frame against its transmission time. The monitoring unit is configured, in the event of an identified lack of authenticity, to corrupt the received Ethernet frame on the physical bus so that none of the other network participants recognizes this Ethernet frame as valid on the physical layer.

### CROSS-REFERENCE TO RELATED APPLICATION

This application claims priority to Germany Patent Application No. 102024209355.6 filed on Sep. 26, 2024, the content of which is incorporated by reference herein in its entirety.

### FIELD

The innovative concept described herein relates to the technical field of network technology. What is proposed is a device for secure communication in an Ethernet-based half-duplex multidrop bus system, wherein the Ethernet frames sent over the multidrop bus are able to be authenticated. Also proposed is a corresponding method for authenticating Ethernet frames in an Ethernet-based half-duplex multidrop bus system.

### BACKGROUND

Ethernet-based half-duplex multidrop bus systems are network topologies in which multiple network entities are able to transmit and receive information on a common bus using the half-duplex method. A multidrop bus (MDB) is a computer bus in which all components are connected to the circuit in a manner galvanically isolated from one other. A multidrop bus allows multiple nodes to be used on a single bus segment. An arbitration procedure is used to determine which device transmits information on the bus while the other devices are listening. Multidrop buses have the advantage of having a simple and therefore inexpensive design. They are also easily expandable.

However, the bus participants in such bus systems are able to be compromised or replaced by fake bus participants relatively easily. A fake bus participant is able to fake the identity of a real bus participant, for example by faking its messages, which thereby appear, incorrectly, to be authentic for the other bus participants.

Current solutions in this regard make provision to implement secure communication on OSI Layer 3 or above (for example MACsec, IPsec, TLS). However, this results in additional delays when transmitting information and also in additional power consumption for processing the required security communication protocol. Implementing a crypto-module, or even implementing a complete security protocol, requires a considerable increase in the required additional silicon surface on the chip, which entails significantly increased costs. In addition to this, in known security solutions implemented on OSI Layer 3 or above, a fake Ethernet frame of a fake bus participant reaches the Ethernet core network before it is even able to be detected.

It would therefore be desirable to improve existing security solutions for authenticating Ethernet frames in multidrop bus systems in such a way that corrupted and/or fake data frames are already recognized and filtered out at the hardware level.

### SUMMARY

This is able to be achieved by way of a device for secure communication in an Ethernet-based half-duplex multidrop bus system and by a corresponding method for authenticating Ethernet frames in such a multidrop bus system having the features as claimed in the independent patent claims. A computer program containing a program code for performing the method is also proposed.

Further implementations and advantageous aspects of the innovative device and of the corresponding method are specified in the respective dependent patent claims.

The innovative device has a physical interface (PHY) for receiving and transmitting the Ethernet frames on the physical layer, that is to say on Open Systems Interconnection (OSI) Layer 1. The device furthermore has a process unit for processing Ethernet frames on the data link layer, that is to say on OSI Layer 2. The device is configured to transmit an Ethernet frame via the physical interface (PHY) only at a transmission time (TO) that has been exclusively reserved and specified by a bus master. According to the innovative concept presented herein, the device has a monitoring unit (GUARD) that is configured to carry out an authenticity check on a received Ethernet frame coming from another network participant by matching the received Ethernet frame against its transmission time (TO), wherein the monitoring unit (GUARD) is configured, in the event of an identified lack of authenticity, to corrupt the received Ethernet frame on the physical bus so that no other network participant recognizes this Ethernet frame as valid on the physical layer (OSI Layer 1).

The associated method includes a step of receiving and transmitting Ethernet frames on the physical layer (OSI Layer 1) by way of a physical interface (PHY), and a step of processing the Ethernet frames on the data link layer (OSI Layer 2) by way of a process unit (e.g., a microcontroller (μC)). An Ethernet frame is in this case transmitted via the physical interface (PHY) only at a transmission time (TO) that has been exclusively reserved and specified by a bus master. According to the innovative concept presented herein, the method includes carrying out an authenticity check on a received Ethernet frame coming from another network participant by matching the received Ethernet frame against its transmission time (TO), wherein the method, in the event of an identified lack of authenticity, includes a further step of corrupting the received Ethernet frame on the physical multidrop bus so that no other network participant recognizes this Ethernet frame as valid on the physical layer (OSI Layer 1).

### BRIEF DESCRIPTION OF THE DRAWINGS

A few example implementations are illustrated by way of example in the drawing and explained below. In the drawings:

FIG. 1 shows a schematic block diagram of an Ethernet network containing multiple network participants,

FIG. 2 shows a schematic view of an innovative device according to one example implementation;

FIG. 3 shows the structure of an Ethernet frame,

FIG. 4 shows the sequence of a PLCA cycle,

FIGS. 5A and 5B show schematic block diagrams for illustrating the OSI layers in a stack and the placement of the innovative monitoring unit within the stack,

FIGS. 6A-6D show schematic block diagrams for illustrating the hardware implementation of the innovative monitoring unit within individual component parts,

FIG. 7 shows a schematic block diagram of an Ethernet network containing multiple network participants, wherein the bus master is equipped with an innovative monitoring unit,

FIG. 8 shows a schematic block diagram of an Ethernet network containing multiple network participants, wherein the bus master and the bus slaves are each equipped with an innovative monitoring unit, and

FIG. 9 shows a schematic block diagram for illustrating an innovative method.

Example implementations are described in more detail below with reference to the figures, wherein elements having the same or a similar function are provided with the same reference signs.

### DETAILED DESCRIPTION

Method steps depicted or described within the scope of the present disclosure may also be carried out in a sequence other than that depicted or described. Moreover, method steps that relate to a particular feature of a device are able to be exchanged with this feature of the device, this also applying the other way round.

The following implementations are described by way of example with reference to the 10BASE-T1S standard. However, it is also conceivable for the innovative concept described herein to be used in other Ethernet-based half-duplex network systems, such as for example 10BASE-T1M. It would also be conceivable for the innovative concept presented herein to be used in all other available Ethernet standards, in particular in PLCA-based Ethernet standards (PLCA: Physical Layer Collision Avoidance).

To improve understanding, a few of the terms used herein will first be defined in more detail as an introductory measure.

Where reference is made herein to different OSI layers, this refers to the individual layers of the ISO/OSI reference model as standardized by the IEEE. The OSI layers may also be referred to as layers.

According to the IEEE, OSI Layer 1 is called the physical layer. It is the bottom layer in the ISO/OSI reference model. This layer provides mechanical, electrical, physical and other functional aids for enabling or disabling physical connections, maintaining them and transmitting bits over them.

OSI Layer 1 may be divided into up to three sublayers, including into the top PCS (physical coding sublayer), the PMA (physical medium attachment) sublayer below it, and the bottom PMD (physical medium dependent) sublayer.

The PCS sublayer defines when a functional connection is established, compensates for different data rates and carries out coding. The PCS sublayer represents an interface between the PMA sublayer below it and the media-independent interface (MII) above it.

The PMA sublayer is responsible for PMA framing, octet synchronization/detection, and scrambling/descrambling.

The PMD sublayer consists of a transceiver for the physical medium. A PMD sublayer also helps to define the physical layer of network protocols. The details of the transmission and reception of individual bits on a physical medium are in particular defined here. These responsibilities comprise bit timing, signal coding, interaction with the physical medium and the characteristics of the line itself.

OSI Layer 2, also called the data link layer, is located directly above OSI Layer 1. The data link layer is tasked with ensuring reliable, that is to say largely error-free, transmission and regulating access to the transmission medium. This is done by splitting the bit data stream into blocks—also known as frames—and adding checksums as part of the channel coding. Defective blocks are thus able to be recognized by the receiver and either discarded or even corrected. However, this layer does not make provision to re-request blocks that have been discarded.

OSI Layer 2 may be divided into two sublayers, including into the media access control (MAC) sublayer (media access control, Layer 2a) and the LLC sublayer (logical link control, Layer 2b). The Ethernet protocol describes both OSI Layer 1 and OSI Layer 2, with CSMA/CD being able to be used as access control on both layers.

The OSI layers may be integrated into different, mutually independent physical component parts of a network entity (also called a network participant). A network participant for use in the innovative multidrop bus may for example have at least one processing unit or process unit, which decides on the data to be transmitted and processes the received data. The process unit may for example be a microcontroller, a processor, a distributed set of processors, and/or a central processing unit (CPU). Thus, the process unit may include one or more processors. The process unit may interact with a memory to perform one or more operations. In addition, an entity may have what is known as a PHY, which converts the digital information into physical information on the bus.

PHY, which is derived from an abbreviation for physical layer, is a term used in computer and communications engineering. PHY denotes a special integrated circuit or a functional group of a circuit that is responsible for coding and decoding data between a purely digital system and the physical medium. PHY also stands here for physical interface.

A PHY is required within a network interface controller to implement the functions of the physical layer, that is to say of OSI Layer 1.

A PHY connects a device, often also referred to as MAC, of the data link layer, that is to say of OSI Layer 2, to a physical medium, such as for example a copper cable. A PHY generally comprises both functions of the PCS sublayer and functions of the PMD sublayer.

An Ethernet PHY is a component that operates on the physical layer, that is to say on OSI Layer 1 of the OSI model. An Ethernet PHY in this case implements the remit of Ethernet assigned to the physical layer. Its purpose is to enable physical access to a connection using analog signals. It is generally connected, via a media-independent interface (MII), to a MAC chip in a microcontroller or another system responsible for the functions of the higher layers.

More specifically, the Ethernet PHY is a chip that implements the hardware transmit and receive function of Ethernet frames; it forms the interface between the analog domain of Ethernet line modulation and the digital domain of packet signaling on the data link layer (OSI Layer 2).

Common Ethernet interfaces comprise for example glass fibers or two to four copper pairs for data communication. A single-pair Ethernet protocol may be used for communication, such as for example what is known as the Single Pair Ethernet (SPE), which uses a single copper cable pair and is still able to communicate at the intended speeds.

However, data security and data integrity also play a role in Ethernet-based bus systems. By way of example, multidrop bus systems are thus used, inter alia, in the industrial environment, but also in the automotive sector. In particular in the latter case, manipulations on the multidrop bus, such as for example falsification of messages, may lead to serious safety deficiencies that, in the worst-case scenario, may endanger life and limb of occupants. It is therefore desirable to have a concept that makes it possible, easily and inexpensively, to ensure secure communication in a multidrop bus system.

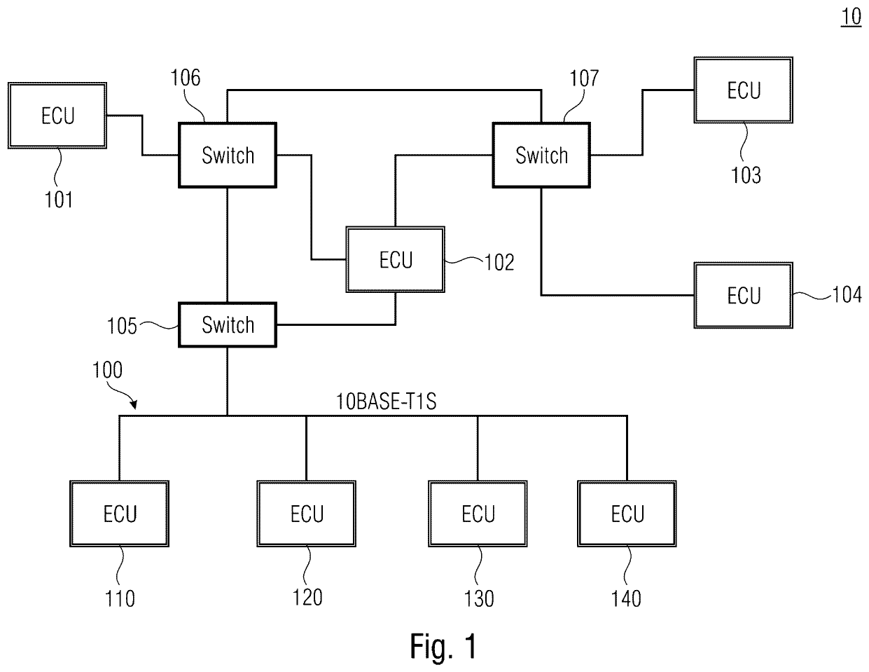

FIG. 1 shows a schematic block diagram of a conventional vehicle bus system 10. The vehicle bus system 10 may have multiple controllers 101, 102, 103, 104; 110, 120, 130, 140, which may also be referred to as electronic control units (ECUs). Each ECU may carry out a different task in the vehicle.

The ECUs 101, 102, 103, 104; 110, 120, 130, 140 may be integrated into different subnetworks. Switches 105, 106, 107 may be used to interconnect the ECUs 101, 102, 103, 104; 110, 120, 130, 140 present in the different subnetworks.

By way of example, it would be conceivable for the ECU 101 to be incorporated in a first subnetwork, the ECU 102 to be incorporated in a (similar or different) second subnetwork, and the ECUs 103, 104 to be incorporated in a (similar or different) third subnetwork. The ECUs 110, 120, 130, 140 may likewise be incorporated in a (similar or different) fourth subnetwork. The subnetworks may differ here for example in terms of their data rate or the medium used. As with the entire vehicle bus system 10, the subnetworks may preferably be Ethernet networks.

The subnetwork 100 containing the ECUs 110, 120, 130, 140 and the switch 105 may be configured for example in the form of an Ethernet-based half-duplex multidrop bus system. In the automotive environment, use is made for example of networks in accordance with the 10BASE-T1S standard, as described here purely by way of example for the ECUs 110, 120, 130, 140. This is an Ethernet network with a data rate of up to 10 Mbit/s, with baseband signaling and twisted-pair cabling. 10BASE-T1S (IEEE 802.cg) is a variant of Automotive Ethernet that supports half-duplex and full-duplex communication and allows either a direct point-to-point connection between two nodes or network participants or the use of a multidrop topology comprising multiple nodes or network participants on a single bus segment.

The multidrop cabling of a bus line offers expansion and scaling possibilities with fewer physical lines and less weight than point-to-point topologies. For a minimal footprint on the controller, the bus line may be easily expanded by adding sensor units.

The main objectives of the 10BASE-T1S physical layer include coordinating transmissions over different media and ensuring cooperative behavior of the nodes on a multidrop bus. This is done, inter alia, by using Physical Layer Collision Avoidance (PLCA) technology to minimize dead time and avoid collisions. PLCA is described in more detail below.

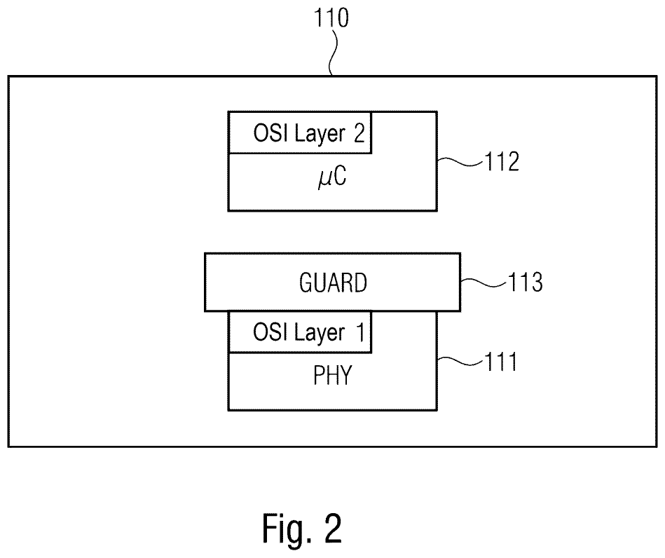

FIG. 2 however first shows, purely by way of example, a schematic block diagram of an innovative device using the example of a bus slave device, such as for example the ECU 110 from FIG. 1. The ECU 110 is configured here in the form of an innovative device for secure communication in an Ethernet-based half-duplex multidrop bus system 100. The innovative device 110 may however also be any other of the network participants 105, 120, 130, 140 described above with reference to FIG. 1. The innovative device may in this case be configured for example in the form of a bus slave device, such as for example the ECUs 110, 120, 130, 140, or else in the form of a bus master device, such as for example the switch 105. Corresponding example implementations are described in more detail with reference to the following figures.

The innovative device 110 depicted by way of example in FIG. 2 has a physical interface 111, also referred to as PHY, for receiving and transmitting Ethernet frames on the physical layer (OSI Layer 1). The device 110 furthermore has a process unit 112 for processing the Ethernet frames on the data link layer (OSI Layer 2).

The device 110 is configured to transmit an Ethernet frame via the physical interface 111 only at a transmission time that has been exclusively reserved and specified by a bus master.

The device 110 furthermore has an innovative monitoring unit 113, which is also referred to as GUARD in the context of the present disclosure. The monitoring unit (GUARD) 113 is configured to carry out an authenticity check on a received Ethernet frame coming from another network participant, for example, from a neighboring ECU 120 (FIG. 1), by matching the received Ethernet frame against its transmission time.

If the monitoring unit (GUARD) 113 in so doing identifies a lack of authenticity of the received Ethernet frame, then it is able to corrupt this Ethernet frame on the physical bus 100 so that no other network participant, such as for example the other ECUs 130, 140 (FIG. 1) or the switch 105, recognizes this Ethernet frame as valid on the physical layer (OSI Layer 1).

The monitoring unit (GUARD) 113 may in this case preferably be integrated in the physical layer, that is to say in OSI Layer 1. By way of example, the monitoring unit (GUARD) 113 may be integrated between the physical layer or OSI Layer 1 and the data link layer or OSI Layer 2. The monitoring unit (GUARD) 113 may include one or more processors.

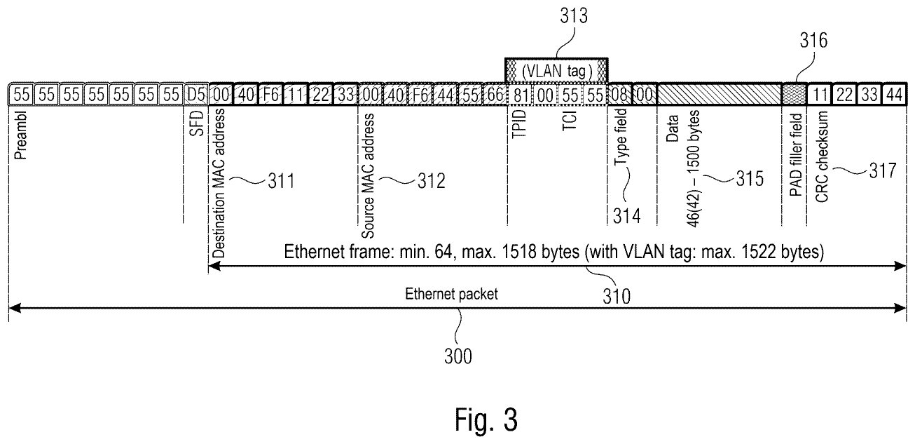

FIG. 3 schematically shows an Ethernet packet 300 having an Ethernet frame 310, as may be used according to the innovative concept presented here. The Ethernet frame 310 may for example be what is known as a tagged MAC frame according to IEEE 802.3.

The Ethernet frame 310 contains a destination MAC address 311, also referred to as destination address, DA for short, coded on six bytes, and a source MAC address 312, also referred to as source address, SA for short, likewise coded on six bytes. The destination MAC address 311 identifies the network station that is intended to receive the data contained in the Ethernet frame 310. This destination MAC address 311 may also be a multicast or broadcast address. The source MAC address 312 identifies the transmitter of the Ethernet frame 310.

In a tagged MAC frame 310 according to IEEE 802.1, an additional four bytes follow as a virtual local area network (VLAN) tag 313. The first two bytes contain the constant 0×8100 (=802.1q TagType), which allow a tagged MAC frame 310 to be recognized as such. Otherwise, the Ethertype field would be in the basic MAC frame at this position here. The value 0×8100 may thus also be regarded as Ethertype for VLAN data, but the actual Ethertype also follows the tag 313 (see below).

In the next two bytes (TCI Tag Control Information), there are then three bits for priority (Class of Service, 0 lowest priority, 7 highest priority), one bit Canonical Format Indicator (CFI), which ensures compatibility between Ethernet and Token Ring, and 12 bits for the VLAN ID. This VLAN tag 313 is followed by the type field (EtherType) 314, which was originally at the position of the VLAN tag 313, of the actual frame 310, with a value other than 0×8100 (for example, 0×0800 for an IPv4 packet in the image).

The type field (EtherType) 314 provides information about the protocol used by the next-higher layer within the payload data. The values are greater than 0×0600. The special value 0×8100 for identifying a VLAN tag 313 is reserved in the type value domain. If a VLAN tag 313 is present, the type field that follows it is not permitted to be 0×8100.

All fields described up to now, which lie between (and including) the destination MAC address 311 and (including) the type field 314, are also referred to under the collective term “network participant-specific information” in the context of this disclosure. The terms “network participant-specific frame information” or “network participant-specific frame data” may also be used synonymously therefor.

The payload data 315 are then coded in data blocks following the type field 314. A maximum of 1500 bytes of payload data may be transmitted per data block. The payload data 315 are interpreted by the protocol specified under type. The data bytes are sent in ascending byte order.

The PAD field 316 is used to bring the Ethernet frame 310 to the required minimum size of 64 bytes. The FCS (Frame Check Sum) field 317 represents a 32-bit CRC checksum. The FCS is calculated over the actual frame 310, that is to say starting with the destination MAC address 311 and ending with the PAD field 316.

As mentioned at the outset, 10BASE-T1S offers collision avoidance on the physical layer, that is to say OSI Layer 1, namely what is known as PLCA: Physical Layer Collision Avoidance. This is a component of the Ethernet reconciliation sublayer, which is located between OSI Layer 1 and OSI Layer 2. The reconciliation sublayer is generally located here between the physical layer, that is to say OSI Layer 1, and the MAC sublayer (media access control, Layer 2a).

The purpose of PLCA is to avoid collisions in the common medium and the associated overheads for retransmission. Essentially, PLCA defines a transmit cycle that is used to choreograph transmit opportunities TOs) on the bus 100. Like in the case of a group of individuals, nothing would be heard properly if all participants were talking chaotically across one another. A PLCA transmit cycle determines speaking opportunities and the order in which the participants speak, but leaves enough room to avoid wasting time waiting for those who have nothing to say.

In PLCA, each node (also called PHY or PHY device), which also includes the innovative device 110, is assigned a unique identifier (ID), what is known as the PHY ID. Only the PHY device that currently has a transmit opportunity (TO) is permitted to transmit data. The transmit opportunities (TO) are assigned in a round-robin algorithm, starting with PHY-ID=0, which is assigned to the bus master or PLCA coordinator. The nodes are in this case generally able to initiate a transmission only during a transmit opportunity (TO) that corresponds to their own ID. The start of a new PLCA cycle is always signaled by the bus master with a synchronization pattern, also referred to as a beacon.

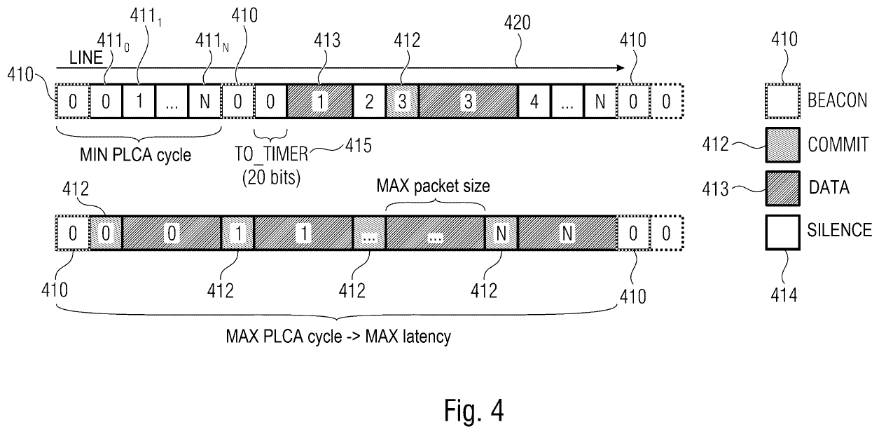

FIG. 4 shows a schematic view of a PLCA cycle. The PLCA cycle itself contains the beacon signal 410 that has just been mentioned, which signals the start of the PLCA cycle, followed by N+1 time slots 4110, 4111, . . . , 411N, which allow N+1 data packets 413 of variable size to be transmitted. The time slots are also referred to as a transmit opportunity (TO) or as a transmission time in the context of this disclosure.

During its transmit opportunity (TO), a PHY 110 may transmit a data packet 413 immediately or has to transmit a COMMIT pattern 412 of SYNC symbols to compensate for any MAC latency and save additional time before a packet 413 is transmitted. If the node does not want to transmit any data, it may also transmit a SILENCE pattern 414 during its time slot 4110, 4111, . . . , 411N.

A node may expand its time slot 4110, 4111, . . . , 411N to accommodate larger transmissions, and high-priority messages may be transmitted earlier. The other nodes wait until a transmitting node has completed its transmission before another node starts its own transmission at the next transmit opportunity (TO). A new time slot 4110, 4111, . . . , 411N starts at the end of a packet transmission, or if nothing is transmitted within a certain time, which is also referred to as TO_TIMER 415.

At the start of each transmit cycle, the transmit opportunity (TO) is first assigned to the node with the PHY-ID=1 on the bus 100. If there are no data to transmit for this node and it cannot carry out a COMMIT 412, then it gives up its transmit opportunity (TO) to the next node on the bus 100.

To better understand the PLCA cycle, it may be helpful to imagine the use of a variable delay line 420 to assign transmit opportunities (TO) to the individual nodes on the bus 100. The time scheme of PLCA consists in synchronizing the abovementioned TO_TIMER 415 such that the maximum latency remains constant in a PLCA cycle. A TO_TIMER 415 is in this case very short (typically 20 bits), and so there is negligible throughput loss when waiting for PHYs that have nothing to transmit.

By way of example, the top left of FIG. 4 thus depicts a PLCA cycle with minimum latency (‘MIN PLCA cycle’), in which no one has anything to transmit, and so the total latency corresponds only to the number of nodes times TO_TIMER. In the following second PLCA cycle, only the nodes with PHY-ID=1 and PHY-ID=3 have something to transmit, and so all other nodes cede their transmit opportunity (TO).

The lower section in FIG. 4, on the other hand, shows a PLCA cycle with maximum latency. Each node here uses the maximum size for a data packet and transmits a COMMIT 412 while it is waiting for the MAC.

The advantage of PLCA is that the individual nodes track the TO_TIMER 415 independently of one other according to the BEACON 410. Since nodes that do not have any data to transmit give up their transmit opportunity (TO), the short time window offered by the TO_TIMER 415 ensures minimal loss of throughput or an increase in latency. This variable delay is similar to the concept of TDMA (time-division multiple access), but PLCA is not a fixed or absolute reference point for temporally defined packets, but rather adapts to the transmission needs of the individual node on the bus.

In summary, the operating principle of PLCA is thus that of dynamically creating transmit opportunities (TO), so that only one network participant at a time is permitted to transmit a packet over the medium at a given time. Each network participant is assigned a unique ID for this purpose. The network participant with the ID=0 is what is referred to as the PLCA coordinator or bus master. It starts a cycle by transmitting a BEACON signal (a kind of heartbeat signal) 410 onto the line, and in this case first perceives its own transmit opportunity (TO).

If the PLCA coordinator with the ID=0 has no data to transmit, the transmit opportunity (TO) is given up after 20 bit times (TO_TIMER) and the next network participant with the ID=1 in turn receives its transmit opportunity (TO). Otherwise, the PLCA coordinator retains the transmit opportunity (TO) until a packet has been transmitted.

A new cycle is started by the bus master or PLCA coordinator whenever the last network participant on the multidrop bus 100 has received its transmit opportunity (TO), regardless of whether it ultimately then discarded its transmit opportunity (TO) or used it to transmit data.

As mentioned at the outset, PLCA is a component of the Ethernet reconciliation sublayer, which is generally located between the physical layer (OSI Layer 1) and the MAC layer (OSI Layer 2). The reconciliation sublayer in this case automatically recognizes when a node has something to transmit. When the MAC supplies data to be transmitted, the reconciliation sublayer postpones the transmission until a transmit opportunity (TO) arises.

In summary, PLCA thus has the following characteristics:
The nodes (PHYs) are assigned statically unique IDs [0 . . . N].
The node with ID=0 is the bus master or PLCA coordinator.
   It transmits a BEACON signal to signal the start of a PLCA cycle and to allow other nodes to synchronize their TO_TIMER,
A PLCA cycle consists of a BEACON and N+1 subsequent transmit opportunities (TO), which allows N+1 data packets of variable size to be transmitted.
   The nodes are able to start their transmission in this case only within their assigned transmit opportunity (TO), wherein their number corresponds to their own node ID.
   A new transmit opportunity (TO) starts if nothing is transmitted during the TO_TIMER, or at the end of a packet transmission.
   The nodes are able to transmit a COMMIT pattern within their transmit opportunity (TO) in order to compensate for MAC latencies before they transmit a packet.

The device 110 according to the implementation may then use all of these characteristics to carry out an authenticity check on a received Ethernet frame 310 coming from another network participant 105, 120, 130, 140 by matching the received Ethernet frame 310 against its transmission time (TO).

As was mentioned at the outset, each Ethernet frame 310 transmitted by a network participant has network participant-specific information that is able to be assigned uniquely and exclusively to this network participant. This information includes the source MAC address SA, the destination MAC address DA, the VLAN tag including one or more of the items of information contained therein, such as for example the VLAN ID, or else the Ethertype. The source MAC address is unique. The other information may also be given a unique character, in particular in combination with the source MAC address, and thus provide further classification for the content of the Ethernet frame 310.

This network participant-specific information is therefore thus explicitly not the payload data transmitted in the Ethernet frame 310, but rather at least one of the following frame sections:
source MAC address,
destination MAC address,
VLAN tag, including one or more of the items of information contained therein, such as for example the VLAN ID, and
Ethertype.

If the PLCA described above is used, each network participant 105, 110, 120, 130, 140 may additionally receive a network participant-specific transmit opportunity (TO) that has been reserved exclusively for it.

An Ethernet frame 310 transmitted by a network participant 105, 110, 120, 130, 140 thus contains some information that should be transmitted only by this specific network participant, and no other network participant. Each network participant has a specific ID (PHY-ID) and a corresponding relative time slot or transmit opportunity (TO) in which each network participant 105, 110, 120, 130, 140 is exclusively permitted to transmit.

The innovative device 110 may then for example combine the PLCA information, such as for example the transmit opportunity (TO) able to be derived via the PHY-ID, with the network participant-specific information contained in the Ethernet frame 310 (such as for example SA/DA/VLAN tag/Ethertype, etc.) in order to match the Ethernet data frame 310 against the transmit opportunity (TO) in which the Ethernet data frame 310 was transmitted.

If a network participant, such as for example the innovative device 110, identifies information on the multidrop bus 100 that was transmitted in a time slot reserved exclusively for itself, or else that was transmitted by another network participant in a time slot that is incorrect for it, then the device 110 is able to corrupt the corresponding Ethernet frame 310 on the physical bus 100 so that none of the other network participants connected to the multidrop bus 100 are able to evaluate the Ethernet frame 310 and the information contained therein as valid on OSI Layer 1.

According to example implementations, the innovative monitoring unit (GUARD) 113, integrated for this purpose in the device 110, may be configured, for the purpose of checking the authenticity of a received Ethernet frame 310, to match the network participant-specific information contained in the Ethernet frame 310 (such as for example SA/DA/VLAN tag/Ethertype, etc.) against with the network participant-specific transmit opportunity (TO).

The matching may be carried out either using an acceptance list or using a blocked list. According to one conceivable implementation, the monitoring unit (GUARD) 113, integrated in the device 110, may be configured to match the network participant-specific information contained in the received Ethernet frame 310 (such as for example SA/DA/VLAN tag/Ethertype, etc.) and the network participant-specific transmission time (TO) against an acceptance list that contains at least the transmission time (TO) and at least one of the following list entries:
the source MAC address, and/or
the destination MAC address, and/or
the VLAN tag, including one or more of the items of information contained therein, such as for example the VLAN ID, and/or
the Ethertype.

The monitoring unit (GUARD) 113 may in this case be configured to authenticate the received Ethernet frame 310 when both the network participant-specific transmission time (TO) of the received Ethernet frame 310 and the network participant-specific information contained in the received Ethernet frame 310 (such as for example SA/DA/VLAN tag/Ethertype, etc.) match the list entries in the acceptance list.

In a second conceivable example implementation, the monitoring unit (GUARD) 113, integrated in the device 110, may be configured to match the network participant-specific information contained in the received Ethernet frame 310 (such as for example SA/DA/VLAN tag/Ethertype, etc.) and the network participant-specific transmission time (TO) against a blocked list that contains at least the transmission time (TO) and at least one of the following list entries:
the source MAC address, and/or
the destination MAC address, and/or
the VLAN tag, including one or more of the items of information contained therein, such as for example the VLAN ID, and/or
the Ethertype.

The monitoring unit (GUARD) 113 may in this case be configured to identify the received Ethernet frame 310 as not authentic when the network participant-specific transmission time (TO) of the received Ethernet frame 310 and/or the network participant-specific information contained in the received Ethernet frame 310 (such as for example SA/DA/VLAN tag/Ethertype, etc.) match at least one of the list entries from the blocked list.

The network participant-specific information, such as for example SA/DA/VLAN tag/VLAN tag/Ethertype, etc., is contained in the Ethernet frame 310 itself and may therefore be ascertained directly from the Ethernet frame 310. The network participant-specific transmit opportunity (TO), on the other hand, may be queried via the PLCA state machine integrated in the PLCA component.

As was described at the outset, the PLCA state information, such as for example the PHY-ID or the network participant-specific transmit opportunity (TO) able to be derived therefrom, is in this case available locally in the component in which the PLCA is implemented, this generally being the reconciliation sublayer located within the physical layer.

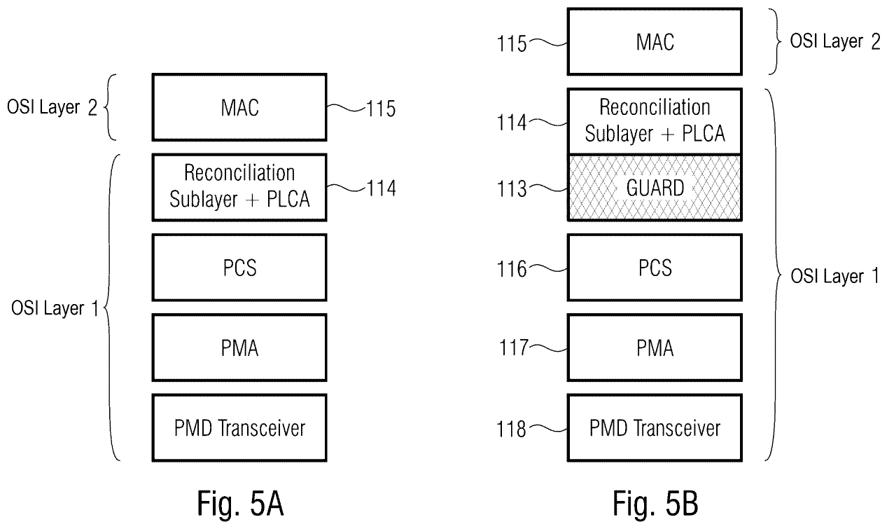

FIGS. 5A and 5B show the hierarchical arrangement of the reconciliation sublayer 114 with the PLCA integrated therein. FIG. 5A in this case first shows a standard stack, wherein the reconciliation sublayer 114, including the PLCA integrated therein, is integrated in the physical layer, that is to say on OSI Layer 1. Above this is the MAC sublayer 115 as sublayer 2b of the data link layer or OSI Layer 2.

FIG. 5B shows a stack in which the innovative monitoring unit (GUARD) 113 is integrated. The monitoring unit (GUARD) 113 may preferably be implemented on the physical layer, that is to say on OSI Layer 1. In one conceivable implementation, as shown here purely by way of example, the monitoring unit (GUARD) 113 may optionally be implemented together with the reconciliation sublayer 114 and/or the PLCA integrated therein. In this case too, above the reconciliation layer 114 is the MAC sublayer 115 as sublayer 2b of the data link layer or OSI Layer 2.

The monitoring unit (GUARD) 113 may however also be arranged between the physical coding sublayer (PCS) 116 and the physical medium attachment sublayer (PMA) 117. It would likewise be conceivable for the monitoring unit (GUARD) 113 to be arranged between the physical medium attachment sublayer (PMA) 117 and the physical medium dependent (PMD) transceiver 118. PMD here is only a convention within the framework of 10BASE-T1S. Generally speaking, the transceiver 118 may be an analog interface that acts as a level converter.

Regardless of the exact arrangement of the monitoring unit (GUARD) 113 in the standard stack, there are several possibilities in real implementations of 10BASE-T1S for implementing the innovative monitoring unit (GUARD) 113 in a network participant, such as for example in the innovative device 110. As was already mentioned at the outset, the OSI layers may be integrated into different, mutually independent physical component parts of a network participant, such as for example the innovative device 110.

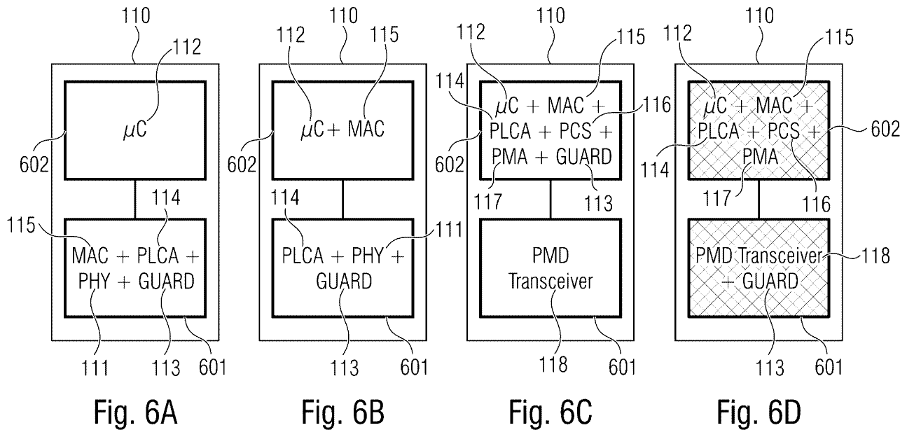

The following FIGS. 6A-6D show, purely by way of example, two component parts 601, 601, which may be provided within the device 110. FIGS. 6A and 6B show different possibilities in which the OSI Layer 1, which contains the physical interface (PHY) 111, and the OSI Layer 2, which contains the process unit (μC) 112, may each be integrated in the two component parts 601, 602. However, the innovative device 110 may of course have further component parts (not explicitly illustrated here), in which for example higher OSI layers are integrated.

FIG. 6A shows a first conceivable example implementation, wherein the monitoring unit (GUARD) 113 is implemented in a first component part 601, which also contains the physical interface 111 on OSI Layer 1. A reconciliation sublayer with integrated PLCA 114 and/or a MAC sublayer 115 may optionally additionally be implemented in the first component part 601. The process unit (μC) 112 on OSI Layer 2 may be implemented in a second component part 602. The communication between the first component part 601 and the second component part 602 may take place here for example by way of an SPI (serial peripheral interface).

This form of implementation offers the advantage that no change to the process unit (μC) 112 is necessary, and so for example any process unit (μC) 112 capable of communicating via the communication interface (for example SPI) that is used is also able to use the innovative GUARD concept.

FIG. 6B shows a second conceivable example implementation, wherein the monitoring unit (GUARD) 113 is again implemented in a first component part 601, which also contains the physical interface 111 on OSI Layer 1. A reconciliation sublayer with integrated PLCA 114 may optionally additionally be implemented in the first component part 601. A MAC sublayer 115 may also optionally be implemented in the second component part 602, which also contains the process unit (μC) 112 on OSI Layer 2. The communication between the first component part 601 and the second component part 602 may take place here for example by way of any xMII (media-independent interface).

This form of implementation offers the advantage that no change to the process unit (μC) 112 is necessary, and so for example any process unit (μC) 112 capable of communicating via the communication interface (for example xMII) that is used is also able to use the innovative GUARD concept.

FIG. 6C shows a second conceivable example implementation, wherein the monitoring unit (GUARD) 113 is implemented in a second component part 602, which also contains the process unit (μC) 112 on OSI Layer 2. A reconciliation sublayer with integrated PLCA 114 and/or a MAC sublayer 115 and/or at least one of the following network protocol layers may optionally additionally be implemented in the second component part 602:
a media access control layer (MAC) 115,
a physical coding sublayer (PCS) 116,
a physical medium attachment sublayer (PMA) 117.

In addition to the physical interface (PHY) 111 on OSI Layer 1, the first component part 601 may have any analog interface, such as for example a physical medium dependent (PMD) transceiver 118. The communication between the first component part 601 and the second component part 602 may take place here for example by way of three pins (Tx|Rx|ED).

This form of implementation offers the advantage of complete integration into the process unit (μC) 112. Bus access may take place using a very simple and inexpensive transceiver 118, since no logic is required on the part of the physical interface (PHY) 111.

FIG. 6D shows a second conceivable example implementation, wherein the monitoring unit (GUARD) 113 is implemented together with the physical medium dependent (PMD) transceiver 118 in the first component part 601. A reconciliation sublayer with integrated PLCA 114 and/or a MAC sublayer 115 of OSI Layer 2 may additionally optionally be integrated in the second component part 602, which also contains the process unit (μC) 112 on OSI Layer 2.

However, the second component part 602 may also contain one or more sublayers of OSI Layer 1, such as for example the physical medium attachment sublayer (PMA) 117 and/or the physical coding sublayer (PCS) 116. The communication between the first component part 601 and the second component part 602 may take place for example by way of three pins (Tx|Rx|ED).

This form of implementation offers the advantage of complete integration into the process unit (μC) 112. Bus access may take place using a very simple and inexpensive analog front end, such as for example a transceiver 118.

Another option, not illustrated explicitly here, is the complete integration of all functions in a single component part or in a single device.

As mentioned at the outset, the monitoring unit (GUARD) 113 is configured, in the event of an identified lack of authenticity, to corrupt the received Ethernet frame 310 on the physical bus 100 so that no other network participant recognizes this Ethernet frame 310 as valid on the physical layer (OSI Layer 1).

One example implementation makes provision here for the monitoring unit (GUARD) 113 to be able to be configured, in the event of a lack of authenticity, to corrupt the received Ethernet frame 310 on the physical bus 100 by virtue of the monitoring unit (GUARD) 113 producing physical collisions on the bus medium. A physical collision should in this case be produced immediately, that is to say at the latest at the next possible transmit opportunity (TO).

By way of example, the physical collisions may be produced using the CSMA/CD algorithm (CSMA/CD: Carrier Sense Multiple Access with Collision Detection) as provided by Ethernet. To ensure that a usable collision is produced, a collision pattern having a length of at least 32 bits should be used.

It is also advantageous for a collision pattern produced for a collision to be different from the frame checksum (FCS) of the already transmitted fragment of the Ethernet frame 310 to be corrupted. The monitoring unit (GUARD) 113 may optionally have a collision counter that is configured to increment its counter status by one digit for each generated collision.

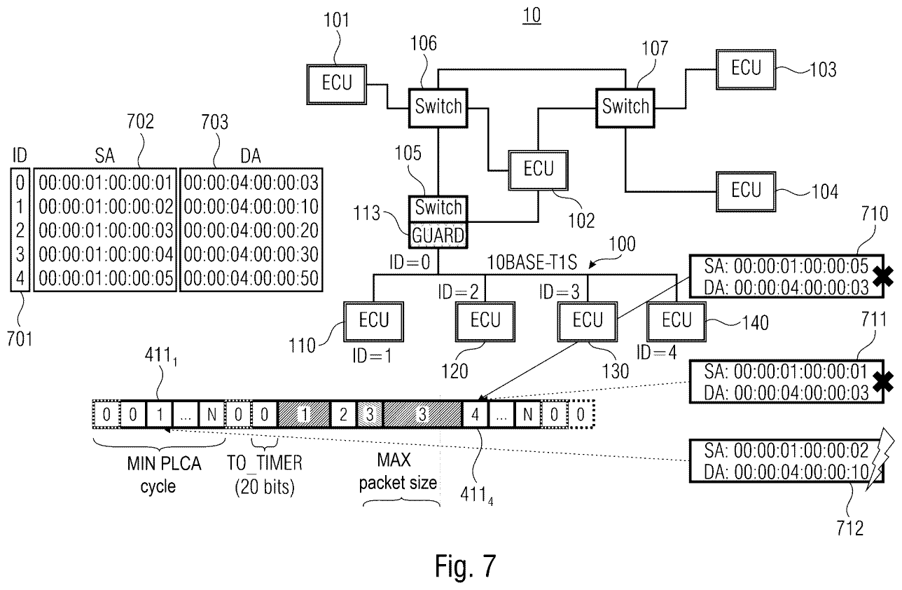

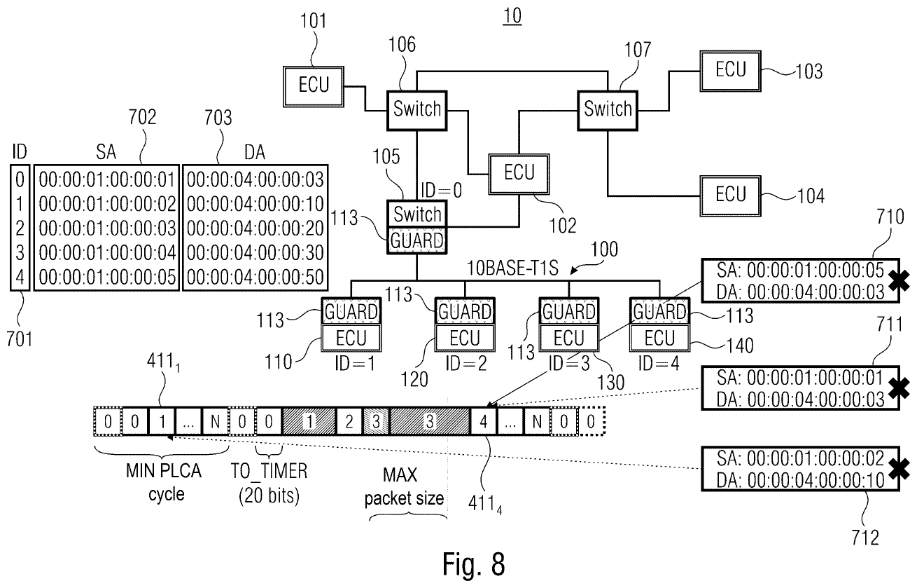

A description is given below, with reference to FIGS. 7 and 8, of different scenarios that are able to be detected by way of an innovative monitoring unit (GUARD) 113 in an Ethernet-based half-duplex multidrop bus system 100. Both figures depict firstly the bus system 10, described above with reference to FIG. 1, to clarify the hardware components, and secondly the PLCA cycle, described above with reference to FIG. 4, to describe the functional level. Elements with the same or a similar function are provided here with the same reference signs as in the previous figures.

FIG. 7 first shows one conceivable example implementation in which the innovative device is configured in the form of the bus master or PLCA coordinator, such as for example in the form of the switch 105. One or more network participants 110, 120, 130, 140 may be connected to the switch 105 in the form of bus slaves, such as for example in the form of ECUs.

The device 105 may have a PLCA component as described above (not illustrated explicitly here), wherein each network participant 105, 110, 120, 130, 140 is assigned a sequential unique PHY-ID. In the example shown here, the switch 105 would have the ID=0 as PLCA coordinator.

By way of example, the first ECU 110 is then given the ID=1, followed by the second ECU 120 with the ID=2, followed in turn by the third ECU 130 with the ID=3, followed in turn by the fourth ECU 140 with the ID=4. All IDs are also listed on the left in the image in box 701.

As was described above, in PLCA, each ID is linked to a transmission time (TO) that has been reserved exclusively for the corresponding network participant 105, 110, 120, 130, 140, and so each network participant 105, 110, 120, 130, 140 is able to transmit on the bus 100 only in a defined transmit opportunity (TO) that has been reserved exclusively for it.

As may be seen in FIG. 7, the innovative device in the form of the switch 105, as the sole network participant, has a monitoring unit (GUARD) 113 according to the innovative concept presented herein. In other words, the other network participants in the form of the bus slaves or ECUs 110, 120, 130, 140 all do not have a monitoring unit (GUARD) 113.

Such a configuration still makes it possible to identify fake Ethernet data frames 310 and fake or unauthorized network participants using the innovative monitoring unit (GUARD) 113. In the example implementation shown here, both the multidrop bus 100 and the core network behind the switch 105 are able to be protected in this case.

As described above, the monitoring unit 113 may be configured for this purpose to match the network participant-specific information contained in a received Ethernet data frame 310, such as for example:
the source MAC address (SA), and/or
the destination MAC address (DA), and/or
the VLAN tag, including one or more of the items of information contained therein, such as for example the VLAN ID, and/or
the Ethertype.

[symbol] against the network participant-specific transmission time (TO). The transmission time (TO) of the received Ethernet frame 310 may in this case be ascertained for example by way of the sequential unique ID of the transmitting network participant. In other words, if the device 105 receives for example an Ethernet data frame 310 at a transmission time (TO) that is linked to the ID=1, then the device 105 knows that this Ethernet data frame 310 must come from the network participant 110. Otherwise, the device 110 corrupts this Ethernet data frame 310 on the physical bus 100.

In the non-limiting example depicted in FIG. 7, each ID (see box 701) is given a respective purely example source MAC address SA (box 702) and a purely example destination MAC address DA (box 703).

In the example scenario (box 710) depicted at the top right, for example, the device 105 receives an Ethernet data frame that was transmitted during a transmit opportunity (TO) 4114 assigned to the fourth ECU 140, which the device 105 may in turn derive based on the unique ID=4.

As indicated in box 710, the received Ethernet frame contains the source MAC address SA: 00:00:01:00:00:05, which correctly corresponds to the fourth ECU 140 with the ID=4 (see box 701 and 702). However, the received Ethernet frame contains a destination MAC address DA: 00:00:04:00:00:03 (see box 710) that does not match the destination address DA stored for the fourth ECU 140 (for example in an acceptance list or blocked list): 00:00:04:00:00:05 (see box 701 and 703). The received Ethernet data frame may thus be identified as not authentic and be corrupted.

According to such an example implementation, although, initially, a received Ethernet frame coming from another network participant 140 may thus have been correctly transmitted at a transmission time (TO) reserved exclusively for this other network participant 140, the monitoring unit (GUARD) 113 is able to identify the fake Ethernet frame as not authentic by matching the network participant-specific information contained in the received Ethernet frame, such as for example SA/DA/VLAN tag/Ethertype, etc., against the transmission time (TO). If the network participant-specific information here does not match the transmission time (TO), as in this case, then the monitoring unit (GUARD) 113 is able to identify the Ethernet frame coming from the other network participant 140 as not authentic and corrupt it on the physical bus 100, for example by intentionally producing a collision using CSMA/CD.

In the second example scenario indicated in box 711, for example, the device 105 again receives an Ethernet data frame that was transmitted in a transmit opportunity (TO) 4114 assigned to the fourth ECU 140, which may in turn be derived based on the unique ID=4.

The received Ethernet frame contains the source MAC address SA: 00:00:01:00:00:01 and the destination MAC address DA: 00:00:04:00:00:03 (see box 711). As may again be seen in boxes 702 and 703, in this case neither the source MAC address contained in the Ethernet frame nor the destination MAC address match the source and destination MAC addresses associated with the ID=4. The source and destination MAC addresses contained in the Ethernet frame (see Box 711) are instead linked to the ID=0. In other words, this Ethernet frame must have actually come from the bus master, that is to say from the innovative device 105. However, since the device 105 is equipped with the innovative monitoring unit (GUARD) 113, it is able to recognize that this Ethernet frame has not come from itself. The device 105 is thus able to automatically identify the received Ethernet frame as not authentic and corrupt it.

According to such an implementation, it may thus be conceivable for a received Ethernet frame 310 coming from another network participant 140 to have been transmitted at a transmission time (TO) reserved exclusively for the device 105 itself. In this case, the monitoring unit 113 is able to recognize the transmission time (TO) of the received Ethernet frame 310 as its own transmission time (TO) and, based thereon, identify the Ethernet frame 310 coming from the other network participant 140 as not authentic, even if the received Ethernet frame 310 otherwise contains the correct network participant-specific information associated with this transmission time (TO), such as for example SA/DA/VLAN tag/Ethertype, etc.

Box 712 shows a third example scenario of a fake Ethernet frame, which however cannot be recognized with certainty with the configuration outlined in FIG. 7. In this example scenario, the device 105 receives an Ethernet frame from the first ECU 110 with the ID=1. The Ethernet frame was in this case correctly transmitted at the transmission time (TO) 4111 associated with the ID=1.

The received Ethernet frame contains the source MAC address SA: 00:00:01:00:00:02 and the destination MAC address DA: 00:00:04:00:00:10 (see box 712). As may be seen in boxes 702 and 703, both the source MAC address contained in the Ethernet frame and the destination MAC address match the source and destination MAC addresses associated with the ID=1. In other words, an Ethernet frame that was transmitted at a correct transmission time (TO) associated with a specific ID and that contains the correct network participant-specific information associated with this ID, such as for example SA/DA/VLAN tag/Ethertype, etc., cannot be recognized with certainty by the configuration depicted in FIG. 7.

FIG. 8 shows a further conceivable configuration that makes it possible to solve this problem as well (box 712). In addition to the bus master 105 (switch), all other bus slaves (ECUs) 110, 120, 130, 140 in the multidrop bus system 100 also each have their own monitoring unit (GUARD) 113 here. For the following description of FIG. 8, it will be assumed that the innovative device is configured here in the form of one of the bus slaves, for example in the form of the first ECU 110.

Otherwise, elements having the same or a similar function are provided with the same reference signs as in the previous figures. Reference is additionally made in this regard to the above description according to FIG. 7. The example scenarios shown in boxes 710 and 711 also match the example scenarios discussed above with reference to FIG. 7, and so reference is likewise made to the above description to avoid repetitions.

The third example scenario shown in box 712 also matches the third example scenario above with regard to the source MAC address and destination MAC address transmitted in the Ethernet frame. In other words, the fake Ethernet frame (box 712) was first correctly transmitted at the transmission time (TO) 4111 associated with the ID=1, and the source and destination MAC addresses contained in the Ethernet frame (see box 712) also match the source and destination MAC addresses linked to the ID=1 (see box 702 and 703).

However, the fake Ethernet frame was in this case not transmitted by the first ECU 110, but rather by another network participant faking being the first ECU 110. However, this fake Ethernet frame coming from the “wrong” first ECU is now able to be recognized by the “real” first ECU 110 by way of the innovative monitoring unit (GUARD) 113 integrated therein, since the “real”first ECU 110 knows that this Ethernet data frame 310 does not come from itself.

According to such an implementation, an Ethernet frame 310 coming from a wrong network participant may thus have been correctly transmitted at a transmission time (TO) reserved exclusively for the innovative device (for example first ECU) 110. However, the monitoring unit (GUARD) 113 is able to recognize the transmission time (TO) of the received Ethernet frame 310 as its own transmission time (TO) and, based thereon, identify the Ethernet frame 310 coming from the wrong network participant as not authentic, even if the received Ethernet frame 310 otherwise contains the correct network participant-specific information associated with this transmission time (TO), such as for example SA/DA/VLAN tag/Ethertype, etc.

The configuration shown in FIG. 8 makes it possible to protect both the core network behind the switch 105 and the multidrop bus system 100 itself from fake messages on the multidrop bus system 100. Each network participant 105, 110, 120, 130, 140 is able to be individually protected for this purpose by its own monitoring unit (GUARD) 113, and thus also protects the rest of the overall vehicle network.

The configurations shown in FIGS. 7 and 8 thus make it possible to detect multiple scenarios:
1. An Ethernet frame identified based on its network participant-specific data, such as for example SA/DA/VLAN tag/priority/Ethertype, etc., is transmitted during an incorrect transmit opportunity (TO), that is to say one assigned to another network participant:
   This scenario is able to be recognized by the network participant that possesses the correct ID associated with the transmission time (TO) of the Ethernet frame with local knowledge.
   This scenario is also able to be recognized by all other network participants with additional network knowledge.
2. An Ethernet frame identified based on its network participant-specific data, such as for example SA/DA/VLAN tag/priority/Ethertype, etc., is transmitted during the correct transmit opportunity (TO) by a wrong network participant:
   This scenario is able to be recognized by the network participant that possesses the correct ID associated with the transmission time (TO) of the Ethernet frame.

A description is to be given below, with reference to FIGS. 7 and 8, of another practical example in order to be able to better understand the innovative concept and its practical benefits. It will be assumed here that the Ethernet-based multidrop bus system 100 is installed in a vehicle network and is compatible with the 10BASE-T1S Ethernet standard.

In this example, the network participant 140 with the ID=4 shall be a headlight. The network participant 110 with the ID=1 shall be a controller capable of providing access to the vehicle.

The headlight, that is to say the network participant 140, is easily reachable by thieves from the outside. Thieves could in this case attempt to access the bus system 100 by replacing the network participant 140 or by connecting an additional fraudulent device to the network participant 140 and thus coupling into the bus 100.

An Ethernet frame 310 transmitted by a fraudulent network participant is able to be recognized by all GUARD devices 105, 110, 120, 130, 140, even if the Ethernet frame was transmitted at transmission time (TO) reserved for the real network participant 140 with the ID=4.

This is able to be achieved by virtue of the monitoring unit (GUARD) 113 for example matching the transmission time (TO) against the source MAC address associated with this ID=4. If these data do not match, the Ethernet frame is corrupted.

If the source MAC address is copied by the attacker, although the source MAC address might possibly match the source MAC address stored for the ID=4, other network participant-specific data contained in the Ethernet frame, such as for example the destination MAC address, the VLAN tag, including one or more of the items of information contained therein, such as for example the VLAN ID, or the Ethertype (or other parts) of the Ethernet frame then might possibly not match the transmission time (TO) linked to the ID=4.

Fake Ethernet frames that are transmitted by another fake network participant during unused transmission times (TO) of the real network participant 110 are also able to be recognized by the real network participant 110.

The attacker would thus have to gain physical access to the real network participant 110, or break the connection to the real network participant 110.

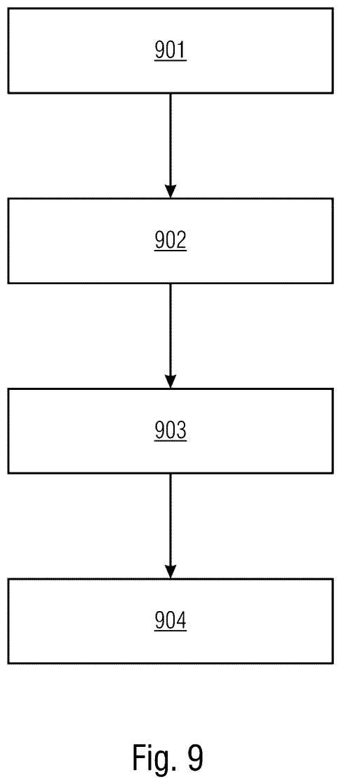

FIG. 9 finally shows a schematic block diagram of an innovative method for authenticating Ethernet frames 310 in an Ethernet-based half-duplex multidrop bus system 100. The individual method steps may in this case also be carried out in an order other than that specified.

Block 901 includes receiving and transmitting Ethernet frames 310 on the physical layer (OSI Layer 1) by way of a physical interface 111, wherein an Ethernet frame 310 is transmitted via the physical interface 111 only at a transmission time (TO) that has been exclusively reserved and specified by a bus master.

Block 902 includes processing the Ethernet frames 310 on the data link layer (OSI Layer 2) by way of a process unit 112.

Block 903 includes carrying out an authenticity check on a received Ethernet frame 310 coming from another network participant 140 by matching the received Ethernet frame 310 against its transmission time (TO).

In the event of an identified lack of authenticity, the method moves to block 904. This includes a further step in which the received Ethernet frame 310 is corrupted on the physical multidrop bus 100 so that no other network participant 120, 130 recognizes this Ethernet frame 310 as valid on the physical layer (OSI Layer 1).

In summary, it may thus be stated that the innovative GUARD concept presented herein provides a possibility for checking the authenticity of Ethernet frames 310 on the physical layer, that is to say on OSI Layer 1.

Network participants may in this case have specific transmit opportunities (TO), which corresponds to a relative time at which a network participant is permitted to transmit data or Ethernet frames. Knowledge about the network participant that is permitted to transmit in a specific transmit opportunity (TO) may be used to identify fake data traffic.

The operations performed here may be divided into recognition and action to be performed.
Recognition:
   GUARD is a function that combines filtering based on the network participant-specific information available in the Ethernet frames 310 with the physical layer status information (provided by PLCA).
   GUARD network participants are able to identify other devices that transmit during the transmit opportunity (TO) of the GUARD network participant itself.
   GUARD identifies Ethernet frames based on the network participant-specific information contained therein, such as for example SA/DA/VLAN tag/priority/EtherType, etc., that was transmitted during an incorrect transmit opportunity (TO) of another network participant.
Action:
   GUARD uses the above knowledge to (locally) filter received Ethernet frames.
   GUARD uses the CSMA/CD characteristic of Ethernet to produce physical collisions when a fault is recognized in order to protect other network participants.

The innovative GUARD concept thus offers the following advantages:
GUARD provides protection based on pre-existing information;
GUARD does not require any additional information on the line or any changes to the protocols on the line;
GUARD is compatible with standard Ethernet communication and supports all protocols;
GUARD does not require software calculations;
GUARD requires hardware support only;
GUARD operates on the bottom OSI layer (that is to say OSI Layer 1);
GUARD provides a solution with lower costs and lower power consumption than existing security protocols on higher OSI layers (OSI Layer 2 and higher) in 10BASE-T1S, and also provides a simple way of protecting against spoofing;
GUARD is therefore a particularly attractive solution for small sensors and actuators; and
GUARD eliminates fake “rogue frames” before they are able to enter the rest of the core network.

The example implementations described above are merely an illustration of the principles of the innovative concept described herein. It goes without saying that modifications and variations of the arrangements and details described herein will be obvious to others skilled in the art. For this reason, the concept described herein is intended to be limited merely by the scope of protection of the following patent claims rather than by the specific details that have been presented herein based on the description and the explanation of the example implementations.

Although some aspects have been described in connection with a device, it goes without saying that these aspects also constitute a description of the corresponding method, with the result that a block or a structural element of a device should also be understood to be a corresponding method step or as a feature of a method step. Analogously thereto, aspects that have been described in connection with a method step or as a method step also constitute a description of a corresponding block or detail or feature of a corresponding device.

Some or all of the method steps may be performed by a hardware apparatus (or using a hardware apparatus), such as for example a microprocessor, a programmable computer or an electronic circuit. In some example implementations, some or more of the most important method steps may be carried out by such an apparatus.

Depending on the specific implementation requirements, example implementations may be implemented in hardware or software or at least partially in hardware or at least partially in software. The implementation may be performed using a digital storage medium, for example a floppy disk, a DVD, a Blu-ray disc, a CD, a ROM, a PROM, an EPROM, an EEPROM or a flash memory, a hard disk or another magnetic or optical memory storing electronically readable control signals that interact or are able to interact with a programmable computer system such that the respective method is performed. For this reason, the digital storage medium may be computer-readable.

Some example implementations thus comprise a data carrier having electronically readable control signals that are capable of interacting with a programmable computer system such that one of the methods described herein is performed.

In general, example implementations may be implemented as a computer program product having a program code, wherein the program code acts to perform one of the methods when the computer program product is executed on a computer.

The program code may also be stored for example on a machine-readable carrier.

Other example implementations comprise the computer program for performing one of the methods described herein, wherein the computer program is stored on a machine-readable carrier. In other words, one example implementation of the method described herein is thus a computer program having a program code for performing one of the methods described herein when the computer program runs on a computer.

A further example implementation of the method described herein is thus a data carrier (or a digital storage medium or computer-readable medium) on which the computer program for performing one of the methods described herein is recorded. The data carrier or the digital storage medium or the computer-readable medium are typically tangible and/or non-volatile.

A further example implementation of the method described herein is thus a data stream or sequence of signals representing the computer program for performing one of the methods described herein. The data stream or the sequence of signals may be configured for example so as to be transferred via a data communication connection, for example the Internet.

A further example implementation comprises a processing device, for example a computer or a programmable logic component, which is configured or adapted to perform one of the methods described herein.

A further example implementation comprises a computer on which the computer program for performing one of the methods described herein is installed.

A further example implementation comprises a device or system configured to transmit a computer program for performing at least one of the methods described herein to a receiver. The transmission may be electronic or optical, for example. The receiver may be for example, a computer, a mobile device, a storage device or a similar device. The device or the system may for example comprise a file server for transmitting the computer program to the receiver.

In some example implementations, a programmable logic component (for example a field-programmable gate array, FPGA) may be used to perform some or all functionalities of the methods described herein. In some example implementations, a field-programmable gate array may interact with a microprocessor to perform one of the methods described herein. In general, the methods in some example implementations are performed by any desired hardware device. The latter may be universally usable hardware, such as a computer processor (CPU) or hardware that is specific to the method, such as for example an ASIC.

### ASPECTS

The following provides an overview of some Aspects of the present disclosure:

Aspect 1: A device for secure communication in an Ethernet-based half-duplex multidrop bus system, the device comprising: a physical interface for receiving and transmitting Ethernet frames on a physical layer; a process unit for processing the Ethernet frames on a data link layer; wherein the device is configured to transmit an Ethernet frame via the physical interface only at a transmission time that has been exclusively reserved and specified by a bus master; and a monitoring unit that is configured to carry out an authenticity check on a received Ethernet frame coming from another network participant by matching the received Ethernet frame against a transmission time of the received Ethernet frame, and wherein the monitoring unit is configured, in the event of an identified lack of authenticity of the received Ethernet frame, to corrupt the received Ethernet frame on the physical bus so that none of the other network participants recognize the received Ethernet frame as valid on the physical layer.

Aspect 2: The device as recited in Aspect 1, wherein each Ethernet frame transmitted by a network participant contains network participant-specific information that is assigned uniquely and exclusively only to the network participant, and wherein each network participant has a network participant-specific transmission time that has been reserved exclusively for it, and wherein the monitoring unit is configured, for the purpose of checking the authenticity of the received Ethernet frame, to match the network participant-specific information contained in the received Ethernet frame against the network participant-specific transmission time of the received Ethernet frame.

Aspect 3: The device as recited in Aspect 2, wherein the network participant-specific information is not a payload data transmitted in the Ethernet frame, but rather at least one of the following frame sections: a source media access control (MAC) address, a destination MAC address, a virtual local area network (VLAN) tag, including one or more items of information contained therein, or an Ethertype.

Aspect 4: The device as recited in Aspect 2, wherein the monitoring unit is configured to match the network participant-specific information contained in the received Ethernet frame and the network participant-specific transmission time against an acceptance list that contains at least the following list entries: a transmission time, and a source media access control (MAC) address, and/or a destination MAC address, and/or a virtual local area network (VLAN) tag, including one or more of the items of information contained therein, and/or an Ethertype, and wherein the monitoring unit is configured to authenticate the received Ethernet frame when both the network participant-specific transmission time of the received Ethernet frame and the network participant-specific information contained in the received Ethernet frame match the list entries in the acceptance list.

Aspect 5: The device as recited in Aspect 3, wherein the monitoring unit is configured to match the network participant-specific information contained in the received Ethernet frame and the network participant-specific transmission time against a blocked list that contains at least the following list entries: a transmission time, and a source media access control (MAC) address, and/or a destination MAC address, and/or a virtual local area network (VLAN) tag, including one or more of the items of information contained therein, and/or an Ethertype, and wherein the monitoring unit is configured to identify the received Ethernet frame as not authentic when the network participant-specific transmission time of the received Ethernet frame and/or the network participant-specific information contained in the received Ethernet frame match at least one of the list entries from the blocked list.

Aspect 6: The device as claimed in any of Aspects 1-5, wherein the monitoring unit is configured, in the event of a lack of authenticity of the received Ethernet frame, to corrupt the received Ethernet frame on the physical bus by virtue of the monitoring unit producing physical collisions on a bus medium.

Aspect 7: The device as recited in Aspect 6, wherein the physical collisions are produced using a carrier sense multiple access with collision detection (CSMA/CD) algorithm as provided by Ethernet.

Aspect 8: The device as recited in Aspect 7, wherein a collision pattern produced for a physical collision is different from a frame checksum of an already transmitted fragment of an Ethernet frame to be corrupted.

Aspect 9: The device as recited in Aspect 7, wherein a collision pattern produced for a physical collision has a length of at least 32 bits.

Aspect 10: The device as recited in Aspect 7, wherein the monitoring unit has a collision counter that is configured to increment a counter status by one digit for each generated physical collision.

Aspect 11: The device as claimed in any of Aspects 1-10, wherein the monitoring unit is implemented in the physical interface.

Aspect 12: The device as recited in Aspect 11, wherein a media access control layer is implemented in the physical interface.

Aspect 13: The device as recited in Aspect 11, wherein a physical layer collision avoidance (PLCA) component is implemented in the physical interface.

Aspect 14: The device as recited in Aspect 13, wherein the monitoring unit is integrated with the PLCA component.

Aspect 15: The device as claimed in any of Aspects 1-14, wherein the monitoring unit is implemented in the process unit.

Aspect 16: The device as recited in Aspect 15, wherein a physical layer collision avoidance (PLCA) component is implemented in the process unit.

Aspect 17: The device as recited in Aspect 16, wherein the monitoring unit is integrated with the PLCA component.

Aspect 18: The device as claimed in any of Aspects 1-17, wherein at least one of the following network protocol layers is implemented in the process unit: a media access control (MAC) layer, a physical coding sublayer (PCS), or a physical medium attachment (PMA) sublayer.

Aspect 19: The device as claimed in any of Aspects 1-18, wherein the Ethernet-based half-duplex multidrop bus system is based on a 10Base-T1S Ethernet standard.

Aspect 20: The device as claimed in any of Aspects 1-19, wherein the device has a physical layer collision avoidance (PLCA) component, wherein each network participant has a sequential unique identifier (ID) linked to a transmission time reserved exclusively for a corresponding network participant, and wherein the monitoring unit is configured to ascertain the transmission time of the received Ethernet frame coming from the other network participant based on the sequential unique ID of the other network participant.

Aspect 21: The device as claimed in any of Aspects 1-20, wherein the device is the bus master in the Ethernet-based half-duplex multidrop bus system and has the monitoring unit as the sole network participant.

Aspect 22: The device as recited in Aspect 21, wherein the received Ethernet frame coming from the other network participant was correctly transmitted at a transmission time reserved exclusively for the other network participant, and wherein the monitoring unit is configured to match the network participant-specific information contained in the received Ethernet frame against the transmission time of the received Ethernet frame, and to identify the received Ethernet frame coming from the other network participant as not authentic if the network participant-specific information contained in the received Ethernet frame does not match the transmission time of the received Ethernet frame.

Aspect 23: The device as recited in Aspect 20, wherein the received Ethernet frame coming from the other network participant was transmitted at a transmission time reserved exclusively for the device, and wherein the monitoring unit is configured to recognize the transmission time of the received Ethernet frame as its own transmission time and, based thereon, to identify the received Ethernet frame coming from the other network participant as not authentic, even if the received Ethernet frame otherwise contains correct network participant-specific information associated with this transmission time.

Aspect 24: The device as recited in Aspect1, wherein the device is one of multiple bus slaves in the Ethernet-based half-duplex multidrop bus system each bus slave having its own monitoring unit.

Aspect 25: The device as recited in Aspect 24, wherein the bus master in the Ethernet-based half-duplex multidrop bus system has its own monitoring unit.

Aspect 26: The device as claimed in any of Aspects 24-25, wherein the received Ethernet frame coming from the other network participant was correctly transmitted at a transmission time reserved exclusively for the other network participant, and wherein the monitoring unit integrated in the device is configured to match the network participant-specific information contained in the received Ethernet frame against the transmission time of the received Ethernet frame, and to identify the received Ethernet frame coming from the other network participant as not authentic if the network participant-specific information contained therein does not match the transmission time of the received Ethernet frame.

Aspect 27: The device as claimed in any of Aspects 24-26, wherein the received Ethernet frame coming from the other network participant was transmitted at a transmission time reserved exclusively for the device, and wherein the monitoring unit is configured to recognize the transmission time of the received Ethernet frame as its own transmission time and, based thereon, to identify the received Ethernet frame coming from the other network participant as not authentic, even if the received Ethernet frame otherwise contains correct network participant-specific information associated with this transmission time.

Aspect 28: A method for authenticating Ethernet frames in an Ethernet-based half-duplex multidrop bus system, the method comprising: receiving and transmitting Ethernet frames on a physical layer by way of a physical interface, wherein an Ethernet frame is transmitted via the physical interface only at a transmission time that has been exclusively reserved and specified by a bus master; processing the Ethernet frames on a data link layer by way of a process unit; carrying out an authenticity check on a received Ethernet frame coming from another network participant by matching the received Ethernet frame against a transmission time of the received Ethernet frame; and in the event of an identified lack of authenticity of the received Ethernet frame, corrupting the received Ethernet frame on a physical bus of the Ethernet-based half-duplex multidrop bus system so that no other network participant recognizes the received Ethernet frame as valid on the physical layer.

Aspect 29: A non-transitory computer-readable medium having computer-readable instructions stored thereon which when executed by a computer system cause the computer system to perform a method for authenticating Ethernet frames in an Ethernet-based half-duplex multidrop bus system, the method comprising: receiving and transmitting Ethernet frames on a physical layer by way of a physical interface, wherein an Ethernet frame is transmitted via the physical interface only at a transmission time that has been exclusively reserved and specified by a bus master; processing the Ethernet frames on a data link layer by way of a process unit; carrying out an authenticity check on a received Ethernet frame coming from another network participant by matching the received Ethernet frame against a transmission time of the received Ethernet frame; and in the event of an identified lack of authenticity of the received Ethernet frame, corrupting the received Ethernet frame on a physical bus of the Ethernet-based half-duplex multidrop bus system so that no other network participant recognizes the received Ethernet frame as valid on the physical layer.

Aspect 30: A system configured to perform one or more operations recited in one or more of Aspects 1-29.

Aspect 31: An apparatus comprising means for performing one or more operations recited in one or more of Aspects 1-29.

Aspect 32: A non-transitory computer-readable medium storing a set of instructions, the set of instructions comprising one or more instructions that, when executed by a device, cause the device to perform one or more operations recited in one or more of Aspects 1-29.

Aspect 33: A computer program product comprising instructions or code for executing one or more operations recited in one or more of Aspects 1-29.

1. A device for secure communication in an Ethernet-based half-duplex multidrop bus system, the device comprising:
a physical interface for receiving and transmitting Ethernet frames on a physical layer;
a process unit for processing the Ethernet frames on a data link layer;
wherein the device is configured to transmit an Ethernet frame via the physical interface only at a transmission time that has been exclusively reserved and specified by a bus master; and
a monitoring unit that is configured to carry out an authenticity check on a received Ethernet frame coming from another network participant by matching the received Ethernet frame against a transmission time of the received Ethernet frame, and
wherein the monitoring unit is configured, in the event of an identified lack of authenticity of the received Ethernet frame, to corrupt the received Ethernet frame on the physical bus so that none of the other network participants recognize the received Ethernet frame as valid on the physical layer.

2. The device as claimed in claim 1,
wherein each Ethernet frame transmitted by a network participant contains network participant-specific information that is assigned uniquely and exclusively only to the network participant, and
wherein each network participant has a network participant-specific transmission time that has been reserved exclusively for it, and
wherein the monitoring unit is configured, for the purpose of checking the authenticity of the received Ethernet frame, to match the network participant-specific information contained in the received Ethernet frame against the network participant-specific transmission time of the received Ethernet frame.

3. The device as claimed in claim 2,
wherein the network participant-specific information is not a payload data transmitted in the Ethernet frame, but rather at least one of the following frame sections:
a source media access control (MAC) address,
a destination MAC address,
a virtual local area network (VLAN) tag, including one or more items of information contained therein, or
an Ethertype.

4. The device as claimed in claim 2,
wherein the monitoring unit is configured to match the network participant-specific information contained in the received Ethernet frame and the network participant-specific transmission time against an acceptance list that contains at least the following list entries:
a transmission time, and
a source media access control (MAC) address, and/or
a destination MAC address, and/or
a virtual local area network (VLAN) tag, including one or more of the items of information contained therein, and/or
an Ethertype, and
wherein the monitoring unit is configured to authenticate the received Ethernet frame when both the network participant-specific transmission time of the received Ethernet frame and the network participant-specific information contained in the received Ethernet frame match the list entries in the acceptance list.

5. The device as claimed in claim 3,
wherein the monitoring unit is configured to match the network participant-specific information contained in the received Ethernet frame and the network participant-specific transmission time against a blocked list that contains at least the following list entries:
a transmission time, and
a source media access control (MAC) address, and/or
a destination MAC address, and/or
a virtual local area network (VLAN) tag, including one or more of the items of information contained therein, and/or
an Ethertype, and
wherein the monitoring unit is configured to identify the received Ethernet frame as not authentic when the network participant-specific transmission time of the received Ethernet frame and/or the network participant-specific information contained in the received Ethernet frame match at least one of the list entries from the blocked list.

6. The device as claimed in claim 1,
wherein the monitoring unit is configured, in the event of a lack of authenticity of the received Ethernet frame, to corrupt the received Ethernet frame on the physical bus by virtue of the monitoring unit producing physical collisions on a bus medium.

7. The device as claimed in claim 6,
wherein the physical collisions are produced using a carrier sense multiple access with collision detection (CSMA/CD) algorithm as provided by Ethernet.

8. The device as claimed in claim 7,
wherein a collision pattern produced for a physical collision is different from a frame checksum of an already transmitted fragment of an Ethernet frame to be corrupted.

9. The device as claimed in claim 7,
wherein a collision pattern produced for a physical collision has a length of at least 32 bits.

10. The device as claimed in claim 7,
wherein the monitoring unit has a collision counter that is configured to increment a counter status by one digit for each generated physical collision.

11. The device as claimed in claim 1,
wherein the monitoring unit is implemented in the physical interface.

12. The device as claimed in claim 11,
wherein a media access control layer is implemented in the physical interface.

13. The device as claimed in claim 11,
wherein a physical layer collision avoidance (PLCA) component is implemented in the physical interface.

14. The device as claimed in claim 13,
wherein the monitoring unit is integrated with the PLCA component.

15. The device as claimed in claim 1,
wherein the monitoring unit is implemented in the process unit.

16. The device as claimed in claim 15,
wherein a physical layer collision avoidance (PLCA) component is implemented in the process unit.

17. The device as claimed in claim 16,
wherein the monitoring unit is integrated with the PLCA component.

18. The device as claimed in claim 1,
wherein at least one of the following network protocol layers is implemented in the process unit:
a media access control (MAC) layer,
a physical coding sublayer (PCS), or
a physical medium attachment (PMA) sublayer.

19. The device as claimed in claim 1,
wherein the Ethernet-based half-duplex multidrop bus system is based on a 10Base-T1S Ethernet standard.

20. The device as claimed in claim 1,
wherein the device has a physical layer collision avoidance (PLCA) component,
wherein each network participant has a sequential unique identifier (ID) linked to a transmission time reserved exclusively for a corresponding network participant, and
wherein the monitoring unit is configured to ascertain the transmission time of the received Ethernet frame coming from the other network participant based on the sequential unique ID of the other network participant.

21. The device as claimed in claim 1,
wherein the device is the bus master in the Ethernet-based half-duplex multidrop bus system and has the monitoring unit as the sole network participant.

22. The device as claimed in claim 21,
wherein the received Ethernet frame coming from the other network participant was correctly transmitted at a transmission time reserved exclusively for the other network participant, and
wherein the monitoring unit is configured to match the network participant-specific information contained in the received Ethernet frame against the transmission time of the received Ethernet frame, and to identify the received Ethernet frame coming from the other network participant as not authentic if the network participant-specific information contained in the received Ethernet frame does not match the transmission time of the received Ethernet frame.

23. The device as claimed in claim 20,
wherein the received Ethernet frame coming from the other network participant was transmitted at a transmission time reserved exclusively for the device, and
wherein the monitoring unit is configured to recognize the transmission time of the received Ethernet frame as its own transmission time and, based thereon, to identify the received Ethernet frame coming from the other network participant as not authentic, even if the received Ethernet frame otherwise contains correct network participant-specific information associated with this transmission time.

24. The device as claimed in claim 1,
wherein the device is one of multiple bus slaves in the Ethernet-based half-duplex multidrop bus system each bus slave having its own monitoring unit.

25. The device as claimed in claim 24,
wherein the bus master in the Ethernet-based half-duplex multidrop bus system has its own monitoring unit.

26. The device as claimed in claim 24,
wherein the received Ethernet frame coming from the other network participant was correctly transmitted at a transmission time reserved exclusively for the other network participant, and
wherein the monitoring unit integrated in the device is configured to match the network participant-specific information contained in the received Ethernet frame against the transmission time of the received Ethernet frame, and to identify the received Ethernet frame coming from the other network participant as not authentic if the network participant-specific information contained therein does not match the transmission time of the received Ethernet frame.

27. The device as claimed in claim 24,
wherein the received Ethernet frame coming from the other network participant was transmitted at a transmission time reserved exclusively for the device, and
wherein the monitoring unit is configured to recognize the transmission time of the received Ethernet frame as its own transmission time and, based thereon, to identify the received Ethernet frame coming from the other network participant as not authentic, even if the received Ethernet frame otherwise contains correct network participant-specific information associated with this transmission time.

28. A method for authenticating Ethernet frames in an Ethernet-based half-duplex multidrop bus system, the method comprising:
receiving and transmitting Ethernet frames on a physical layer by way of a physical interface,
wherein an Ethernet frame is transmitted via the physical interface only at a transmission time that has been exclusively reserved and specified by a bus master;
processing the Ethernet frames on a data link layer by way of a process unit;
carrying out an authenticity check on a received Ethernet frame coming from another network participant by matching the received Ethernet frame against a transmission time of the received Ethernet frame; and
in the event of an identified lack of authenticity of the received Ethernet frame, corrupting the received Ethernet frame on a physical bus of the Ethernet-based half-duplex multidrop bus system so that no other network participant recognizes the received Ethernet frame as valid on the physical layer.

29. A non-transitory computer-readable medium having computer-readable instructions stored thereon which when executed by a computer system cause the computer system to perform a method for authenticating Ethernet frames in an Ethernet-based half-duplex multidrop bus system, the method comprising:
receiving and transmitting Ethernet frames on a physical layer by way of a physical interface,
wherein an Ethernet frame is transmitted via the physical interface only at a transmission time that has been exclusively reserved and specified by a bus master;
processing the Ethernet frames on a data link layer by way of a process unit;
carrying out an authenticity check on a received Ethernet frame coming from another network participant by matching the received Ethernet frame against a transmission time of the received Ethernet frame; and
in the event of an identified lack of authenticity of the received Ethernet frame, corrupting the received Ethernet frame on a physical bus of the Ethernet-based half-duplex multidrop bus system so that no other network participant recognizes the received Ethernet frame as valid on the physical layer.
